(19) United States
(12) Patent Application Publication
(10) Pub. No.: US 2006/0156525 A1
(43) Pub. Date: Jul. 20, 2006

(54) Holster manufacturing system and method of making

(76) Inventors: Taylor Jenkins, Garden City, ID (US); Tony Senn, Garden City, ID (US); Mike Lowe, Garden City, ID (US)

Correspondence Address: DYKAS, SHAVER & NIPPER, LLP, P.O. BOX 877, BOISE, ID, 83701-0877, US

(21) Appl. No.: 11/243,490

(22) Filed: Oct. 3, 2005

Related U.S. Application Data
(60) Provisional application No. 60/615,183, filed on Oct. 1, 2004.

(51) Int. Cl. B23Q 17/00; F41C 33/00

(52) U.S. Cl. 29/407.1; 29/428; 224/193

(57) ABSTRACT

The invention is a method of manufacturing plastic holsters for handguns which utilize a standardized outer shell which is bonded with an inner shell. The interior surface of the inner shell is configured to correspond to the surface features of a handgun. The inner shell is bonded to the outer shell to form one unitary piece. A mold core may be used, with the core including ridges which form ribs in the inner surface of the holster or the inner shell of the holster, with the ridges being closely configured to match the surface features of the specific handgun for which it is adapted. By modifying the depth of the grooves between ridges on the core, interior surfaces for holsters for various models of handguns can be quickly and inexpensively designed.

### CROSS-REFERENCE TO RELATED APPLICATIONS

This application claims the priority date of the provisional application entitled HOLSTER MANUFACTURING SYSTEM AND METHOD OF MAKING filed by Taylor Jenkins, et al., on Oct. 1, 2004 with application Ser. No. 60/615,183, the disclosure of which is incorporated herein by reference.

### DESCRIPTION

1. Field of the Invention

The invention relates to generally to a method of manufacture, and more specifically to a method of manufacture of plastic handgun holsters.

2. Background of the Invention

Holsters for handguns have traditionally been made of leather. In recent times, certain types of plastic materials have proven to be very suitable for making holsters for handguns also. Some of these plastic materials are extremely durable and can be manufactured by methods suitable for mass production of plastics. These methods include injection molding, and other types of manufacturing suitable for plastics, which would not work for leather. As plastics have been tried in the manufacturing of holsters for handguns, the initial designs were similar to designs made of leather. They were basically a cavity with sidewalls which are generally suited to the outside shape of the handgun, and the handgun was placed into the handgun holster for a fit similar to that achieved with leather. However, since plastic can be manufactured to very close tolerances, a much more secure fit for the handgun can be achieved, which causes the handgun to be gripped very securely and to be held securely inside the holster. By using a suitable plastic material, a handgun holster can be made which has much closer tolerances than a similar leather holster, which can allow the handgun to slide cleanly into and out of the holster, and not let it rattle around inside the holster. A precise degree of friction can be built into the holster for securing the handgun within the holster.

A problem with a plastic handgun holster which has close tolerances and which is made to fit closely with a handgun is that the mold for making the plastic handgun is very expensive. Once the mold is made, then handguns can be made quite inexpensively, but the initial mold is expensive. There are a large number of different makes and models of handguns, and each of them have a different 3-dimensional shape. A plastic holster which is made to have a close tolerance fit with one handgun, might be too tight for another handgun, or it may allow a different handgun to be held too loosely within the holster. There are hundreds of different handgun shapes, and making an injection mold for each shape is quite expensive, if not prohibitive.

What is needed is a manufacturing process which allows a close tolerance plastic holster to be made for a number of different shapes of handguns. Such a method should provide a technique for changing the internal surface of the holster without having to redesign the entire mold for all of the different variations of handgun shapes that exists.

### SUMMARY OF THE INVENTION

The invention is a method of manufacturing handgun holsters which are suitable for use with a number of different sizes of gun models, with a process that does not require a completely different mold for injecting plastic for each different shape of gun. One version of the invention is accomplished by first configuring an outer shell of the handgun made of molded plastic. The outer shell has an inner surface and an outer surface, with the outer surface having the desired holster exterior features and the inner surface being configured to fit with a number of inner shells, with the inner shells each specifically configured for different handguns. The inner shells are also made of molded plastic, and each have an exterior surface designed for engagement with the inner surface of the outer shell, and each of the inner shells have an interior surface which is designed for close tolerance interfitting engagement with the surface features of a selected handgun. The inner shell is specifically selected for a specific handgun, and its interior surface is designed for a close tolerance fit to that handgun. The outer shell and the inner shell are joined together to form a molded plastic handgun holster which has the desired external features and also which has an interior surface which closely interfits with the surface features of a selected handgun. By utilizing a different inner shell, a plastic handgun holster can be manufactured for a different model merely by changing the configuration and selection of the inner shell. Just changing the inner surface of the finished handgun is much easier than having to retool to make both the inner surface and the outer surface in a separate injection mold for each handgun.

The outer shell and the inner shell can be joined by heat, chemical bonding, sonic energy, mechanical connection means, or by the use of interfitting features such as snaps, detents, prongs, tangs or other interfitting features.

One version of the manufacturing method of the invention utilizes an inner shell which is formed as a flat unit and is folded to the desired shape by folding along fold lines, with the resultant shape congruent with the surface features of the selected handgun. Once folded into the desired shape, the inner shell is inserted into the outer shell and the two shells are bonded together. By utilizing an inner shell and an outer shell to form a holster, the outer shell can be made from a standardized outer mold. Several sizes of standardized outer shells would be utilized, with each standardized outer shell being able to interfit with a number of inner shells configured for particular handguns. The standardized outer shells would for instance be large, medium and small, and depending on the size of the handgun, the inner shells for different handguns would fit within the appropriate size of the standardized outer shells.

The manufacturing method of the invention can include the manufacture of mold cores. A mold core is a 3-dimensional shape that is formed in the shape to be compatible to the handgun which the holster is designed for close interfitting relationship. A mold would be made which defines the exterior of the holster, and material would be injected between the mold for the outer holster and the mold core, with the result that the interior of the holster is configured for close tolerance fitting with a particular handgun model.

One configuration of the mold core which is desirable and which would reflect in corresponding structures in the holster interior is a series of ridges and grooves on the mold core. The interstices between the ridges provide a space into which liquid material fills, resulting in projecting fins on the interior of the holster. These fins on the holster interior provide a contact area for the handgun as it moves in and out of the holster. The fins are preferred over flat surfaces because they result in less resistance to inserting and extracting the handgun, while maintaining a close tolerance fit around the features of the handgun.

Another advantage of using ribs on a core for creating an inner mold would be that a core for a small handgun would result in relatively longer ribs extending from the inner shell to contact the handgun. For a different model of handgun, a new core could be formed by trimming down the ribs. Thus, one core could serve as a basis for more than one handgun.

The purpose of the foregoing summary is to enable the public, and especially the scientists, engineers, and practitioners in the art who are not familiar with patent or legal terms or phraseology, to determine quickly from a cursory inspection, the nature and essence of the technical disclosure of the application. The summary is neither intended to define the invention of the application, which is measured by the claims, nor is it intended to be limiting as to the scope of the invention in any way.

Still other objects and advantages of the present invention will become readily apparent to those skilled in this art from the following detailed description describing only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE DRAWINGS

FIG. 1 is an exploded view of the components of the holster manufactured by the method of the invention.

FIG. 2 is an exploded view of the holster components, with the flat molded insert folded to form the inner shell.

FIG. 3 is a front view of the holster made by the process of the invention, with a handgun seated in it.

FIG. 4 is a perspective view of a core, which is utilized in the method of manufacturing of the invention.

FIG. 5 is a perspective view of a mold, which is utilized to form a core that is utilized in the method of manufacturing of the invention.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

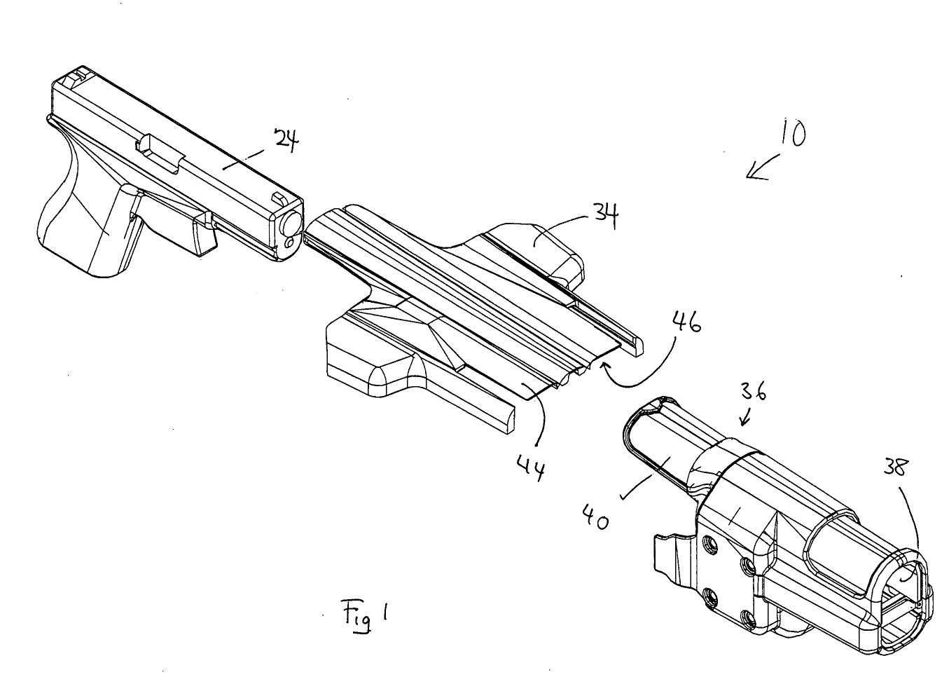

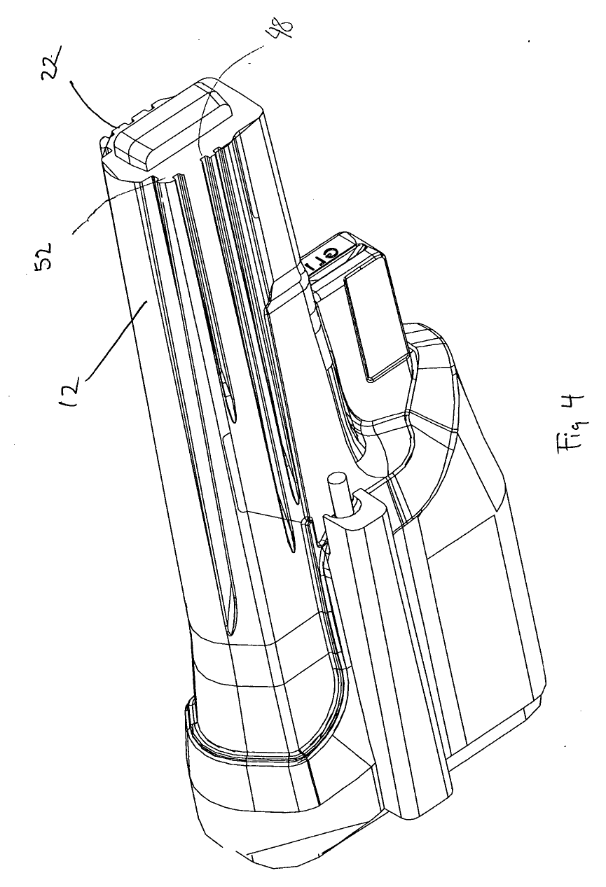

FIGS. 1 through 5 shows several preferred embodiments of the method of manufacturing of the invention. The invention is a method of manufacturing of injected molded plastic handgun holsters which can accommodate a variety of sizes of handguns without making an entirely new injection mold. As shown in FIG. 1, in one version of the invention, the holster 10 can be made of two pieces. An outer shell 36 is of a uniform size and an inner shell 42 is utilized which can be placed inside the outer shell 36. The outer shell 36 provides the desired exterior surface of the holster, and the inner shell fits within the outer shell 36 and provides the desired configuration of the inner surface 46 of the holster. The inner shell 42 is permanently attached to the outer shell 36 and may be attached using a number of non-bonding techniques. This can be through the use of a chemical solvent, cement, sonic bonding, heat bonding, rivets and various clips, detents and prongs. Thus, by changing the configuration of the inner surface 46 of the inner shell 42 to match the surface features of a particular handgun 24, the outer shell 36 does not have to be changed. The shape of the inner shell can be changed by modifying a core 12. A core 12 is shown in FIG. 4.

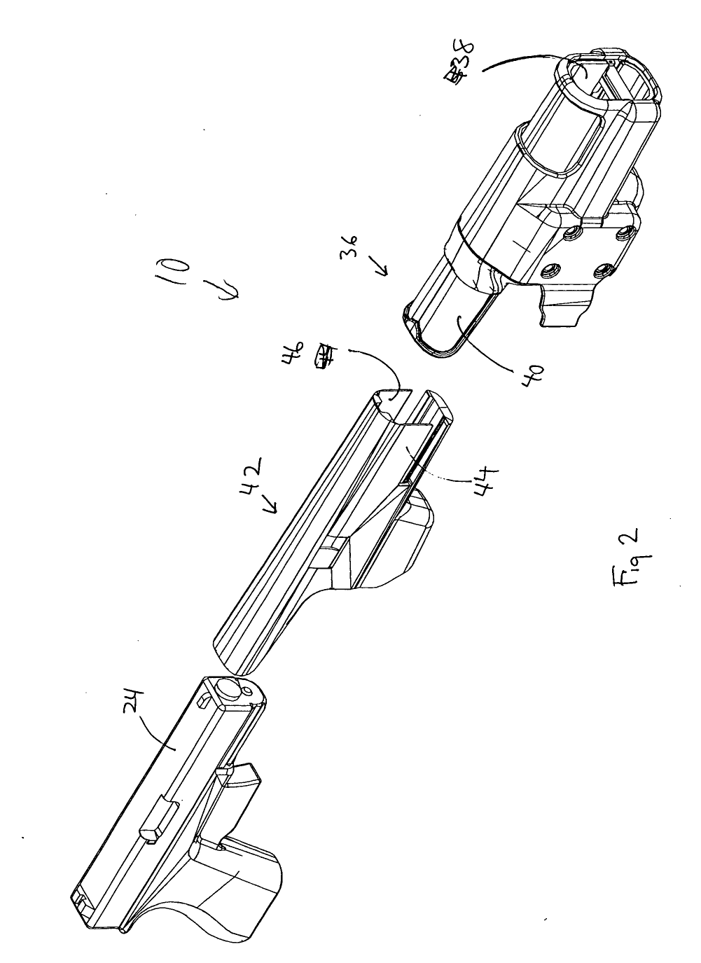

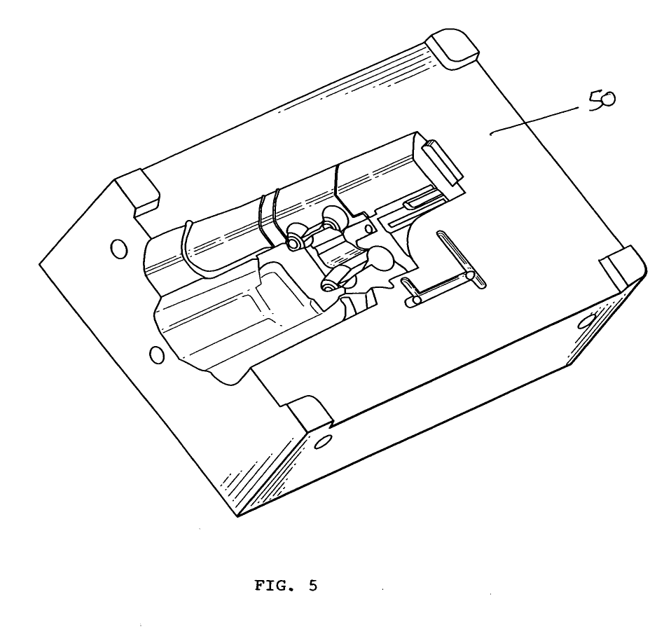

FIG. 5 also shows an additional way of arriving at a different size inner shell 42. This is through the use of a flat molded insert 34 as shown in FIG. 1. The flat molded insert 34 is made in a mold in which the insert is laid out flat. Built into the design of the flat molded insert 34 are hinges that allow the flat molded insert 34 to be folded to form the shape of the inner shell 42. Once folded into the shape of the inner shell 42, the flat molded insert can be secured edge-to-edge, or stabilized in that shape by bonding it to the interior of the outer shell 36. FIG. 5 shows a flat molded insert 34. FIG. 1 shows a flat molded insert 34 adjacent to an outer shell 36. The outer shell 36 has an outer surface 40 and an inner surface 38. As shown in FIG. 2, the flat molded insert 34 is folded into the shape of an inner shell 42, and has an outer surface 44 and an inner surface 46. The inner surface 46 corresponds to the surface features of a particular handgun 24. The outer surface 44 corresponds to the shape of the inner surface 38 of the outer shell 36. The inner shell 42 is inserted into the outer shell 36 and bonded together by any one of a number of known bonding means.

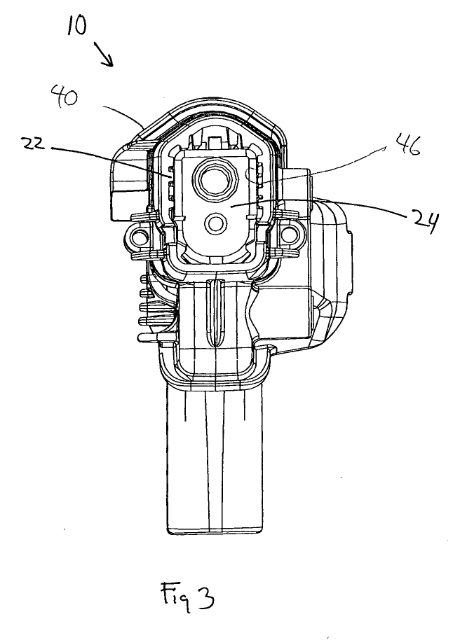

Another manufacturing method of the invention is the use of a core 12 which is shown in FIG. 4. The core 12 can be utilized to define the inner surface of a handgun holster 10. By utilizing a core 12, handgun holsters for different sizes and shapes of handguns can be made by modifying the core 12. The core 12 is modified by changing the surface contour formed by a number of ridges 52. By deepening the grooves 48 between the ridges 52 or shaving down the ribs 22, the interior of the holster can be changed in shape to match the surface of a handgun 24. FIG. 3 shows a handgun 24 inserted into a holster 10, with a number of ribs 22 formed adjacent to the surface contours of the handgun 24, and securely holding it in place. Use of a core 12 is shown in FIG. 4 and modifications of that core allows for less expensive molds to be made for different sizes and shapes of handguns. The core is easily modified by deepening the valleys 48 or reducing the ridges so that they form ribs 22 which match the contour of any particular gun.

FIG. 4 shows a core 12 as placed inside a mold 14 in order to form a holster 10. The mold 14 in this place is comprised of a half mold A and a half mold B. The half molds A and B are placed together and serve to form the outer contour of the holster that is formed in the mold. Core 12 is placed inside the mold half A and mold half B, and the exterior surface of the core 12 forms the interior surface of the holster 10. Material is injected into the space between the core 12 and the mold halves A and B. Once the injection material has dried, the mold halves A and B and core 12 are removed, leaving a handgun holster 10. Use of the core 12 provides improved flexibility and economics in making a holster shell in two different ways. The core 12 is much cheaper to build than mold half A and mold half B. This feature is utilized by making a line of holsters that have a consistent exterior profile. The exterior profile is formed by the mold halves A and B. Without having to have additional molds for other models of handguns, the core 12 can be built to accommodate different handguns. The core 12 is basically the shape of the chosen handgun with additional ribbing and grooves added to the handgun shape to form ribs that will be formed within the interior of the holster. Thus, what appears to be a groove on the core will become a rib on the interior of the handgun

The core 12 can be modified to function with different sizes and models of handguns by taking the basic core shape and removing the metal from the bottom of the valleys 48 found on the core 12. The valleys 48 on the core, become ribs 22 in the handgun. The ribs 22 are specifically designed to provide a close fit for a selected handgun. By deepening the valleys 24 on the core 12, the ribs 22 in the holster are increased in length, and can accommodate different handgun shapes. Thus the holster shown in FIG. 4 can be made in a variety of sizes and configurations to fit different handguns, but the outer surface 40 will be identical in each version, but the inner surface 46 will be tailored to fit a specific handgun. FIG. 5 shows a mold half 50.

Besides the core 12 providing the flexibility of being easily modified to accommodate different handgun shapes, a completely separate core can also be manufactured for different molds of handguns. Creating a separate mold for each handgun would still be cheaper than building an entirely new mold for each model of handguns.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

We claim:

1. A method of manufacturing handgun holsters of various sizes to fit different gun models, comprising the steps of:
configuring an outer shell of molded plastic, said outer shell having an inner surface and an outer surface, with said outer surface having desired holster exterior features, and said inner surface being configured to fit with a plurality of inner shells for different handguns;
configuring a plurality of inner shells of molded plastic, each with an exterior surface designed for attachment to said inner surface of said outer shell, and with an interior surface designed for interfitting engagement with surface features of a selected handgun;
selecting an inner shell based on the handgun the holster is to be made for; and
joining said outer shell and said selected inner shell to form a holster with an outer surface with desired holster exterior features, and an interior which interfits with surface features of a selected handgun.

2. The method of manufacturing handgun holsters of claim 1, in which the outer shell and inner shell are joined by heat.

3. The method of manufacturing handgun holsters of claim 1, in which the outer shell and inner shell are joined by chemical bonding.

4. The method of manufacturing handgun holsters of claim 1, in which the outer shell and inner shell are joined by sonic energy.

5. The method of manufacturing handgun holsters of claim 1, in which the outer shell and inner shell are joined by mechanical connection means.

6. The method of manufacturing handgun holsters of claim 1, in which mechanical connection means joining the outer shell and inner shell are interfitting features, such as snaps, detents, prongs or tangs.

7. The method of manufacturing handgun holsters of claim 1, in which the inner shell is formed as a flat unit, and is folded to the desired shape congruent with the surface features of a selected handgun, and then inserted into said outer shell, and the two are bonded together.

8. A method of manufacturing handgun holsters of various sizes to fit different gun models, comprising the steps of:
configuring an outer shell of molded plastic, said outer shell having an inner surface and an outer surface, with said outer surface having desired holster exterior features, and said inner surface being configured to fit with a plurality of inner shells for different handguns;
configuring a plurality of inner shells of molded plastic, each with an exterior surface designed for attachment to said inner surface of said outer shell, and with an interior surface designed for interfitting engagement with surface features of a selected handgun, in which the inner shell is formed as a flat unit;
selecting an inner shell based on the handgun the holster is to be made for; and folding the flat inner shell to the desired shape congruent with the surface features of a selected handgun, and then inserting the inner shell into said outer shell; and
joining said outer shell and said selected inner shell to form a holster with an outer surface with desired holster exterior features, and an interior surface which interfits with surface features of a selected handgun.

9. The method of manufacturing handgun holsters of claim 8, in which the outer shell and inner shell are joined by heat.

10. The method of manufacturing handgun holsters of claim 8, in which the outer shell and inner shell are joined by chemical bonding.

11. The method of manufacturing handgun holsters of claim 8, in which the outer shell and inner shell are joined by sonic energy.

12. The method of manufacturing handgun holsters of claim 8, in which the outer shell and inner shell are joined by mechanical connection means.

13. The method of manufacturing handgun holsters of claim 12, in which mechanical connection means joining the outer shell and inner shell are interfitting features, such as snaps, detents, prongs or tangs.

14. A method of manufacturing handgun holsters of various sizes to fit different gun models, comprising the steps of:
configuring a mold which defines contours of an outer surface of a holster, with said outer surface having desired holster exterior features, in which liquid material can be injected to form said outer holster surface;
configuring a plurality of mold cores, for placement inside said mold, which define an interior surface of said holster, designed for interfitting engagement with surface features of a selected handgun;
choosing a mold core based on which handgun model the holster is to be made to fit, and when a mold core is selected, placing said mold core inside and spaced apart from said mold;
injecting or applying liquid material in said mold to form a holster that has desired holster exterior features defined by said mold, and which has in interior surface formed by said mold core, which interfits with surface features of a selected handgun;
removing said holster from between said mold and said mold core.

15. The method of claim 14, in which said mold core is shaped like the handgun the holster is to fit, and which further includes fins extending out from the mold core, with interstices between the fins, so that when liquid material fills said mold, the material in the interstices form fins on the interior of the holster.

16. A method of manufacturing security holsters for multiple pistol configurations comprising:
selecting a handgun for use within a handgun specific security holster;
configuring an inner mold with specific ribbing for securely receiving said handgun;
attaching a standard outer mold usable on a plurality of security holster configurations; and
inserting a molding material in between said inner mold and said standard outer mold in order to form said handgun specific security holster.

17. A security holster gun mold comprising:
a standard outer mold for creating external features and shapes of said security holster gun mold; and
an inner mold attachable to said standard outer mold for creating internal features and shapes wherein said inner mold further comprises rib forming grooves running parallel to a long axis of said inner mold for creating ribs during a molding process for allowing multiple guns to be molded using said standard outer mold.

18. The security holster gun mold of claim 17, wherein said rib forming grooves are adjustable allowing said inner mold to be adapted for molding a plurality of security holster configurations.

19. A holster manufacturing system for manufacturing holsters of different sizes to fit different gun models, comprising;
an outer shell of molded plastic, said outer shell having an inner surface and an outer surface, with said outer surface having desired holster exterior features, and said inner surface being configured to fit with a plurality of inner shells for different handguns;
a plurality of inner shells of molded plastic, each with an exterior surface designed for attachment to said inner surface of said outer shell, and with an interior surface designed for interfitting engagement with surface features of a selected handgun; wherein
said inner shell is selected based on the handgun the holster is to be made for, and the outer shell and said selected inner shell are joined to form a holster with an outer surface with desired holster exterior features, and an interior which interfits with surface features of a selected handgun.

20. The manufacturing system for handgun holsters of claim 19, in which the outer shell and inner shell are joined by heat.

21. The manufacturing system for handgun holsters of claim 19, in which the outer shell and inner shell are joined by chemical bonding.

22. The manufacturing system for handgun holsters of claim 19, in which the outer shell and inner shell are joined by sonic energy.

23. The manufacturing system for handgun holsters of claim 19, in which the outer shell and inner shell are joined by mechanical connection means.

24. The manufacturing system for handgun holsters of claim 23, in which mechanical connection means joining the outer shell and inner shell are interfitting features, such as snaps, detents, prongs or tangs.

25. The manufacturing system for handgun holsters of claim 19, in which the inner shell is formed as a flat unit, and is folded to the desired shape congruent with the surface features of a selected handgun, and then inserted into said outer shell, and the two shells are bonded together.

26. A manufacturing system for handgun holsters of various sizes to fit different gun models, comprising;
an outer shell of molded plastic, said outer shell having an inner surface and an outer surface, with said outer surface having desired holster exterior features, and said inner surface being configured to fit with a plurality of inner shells for different handguns;
a plurality of inner shells of molded plastic, each with an exterior surface designed for attachment to said inner surface of said outer shell, and with an interior surface designed for interfitting engagement with surface features of a selected handgun, in which the inner shell is formed as a flat unit, with the inner shell selected based on the handgun the holster is to be made for; wherein
said inner shell is configured for folding to the desired shape congruent with the surface features of a selected handgun, and for insertion into the said outer shell for joining said outer shell and said selected inner shell to form a holster with an outer surface with desired holster exterior features, and an interior surface which interfits with surface features of a selected handgun.

27. The manufacturing system for handgun holsters of claim 26, in which the outer shell and inner shell are joined by heat.

28. The manufacturing system for handgun holsters of claim 26, in which the outer shell and inner shell are joined by chemical bonding.

29. The manufacturing system for handgun holsters of claim 26, in which the outer shell and inner shell are joined by sonic energy.

30. The manufacturing system for handgun holsters of claim 26, in which the outer shell and inner shell are joined by mechanical connection means.

31. The method of manufacturing handgun holsters of claim 30, in which mechanical connection means joining the outer shell and inner shell are interfitting features, such as snaps, detents, prongs or tangs.

32. A manufacturing system for handgun holsters of various sizes to fit different gun models, comprising:
a mold which defines contours of an outer surface of a holster, with said outer surface having desired holster exterior features, in which liquid material can be injected to form said outer holster surface;
a plurality of mold cores, for placement inside said mold, which define an interior surface of said holster, designed for interfitting engagement with surface features of a selected handgun, with said mold core selected based on which handgun model the holster is to be made to fit; wherein
said mold core is designed to be placed inside and spaced apart from said mold, so that liquid material may be injected between said mold and said mold core, to form a holster that has desired holster exterior features defined by said mold, and which has in interior surface formed by said mold core, which interfits with surface features of a selected handgun.

33. The manufacturing system for handgun holsters of claim 32, in which said mold core is shaped like the handgun the holster is to fit, and which further includes fins extending out from the mold core, with interstices between the fins, so that when liquid material fills said mold, the material in the interstices form fins on the interior of the holster.

34. A manufacturing system for handgun holsters of various sizes to fit different gun models, comprising:
an inner mold with specific ribbing for securely receiving said handgun; and
a standard outer mold usable on a plurality of security holster configurations; wherein molding material is inserted between said inner mold and said standard outer mold in order to form said handgun specific security holster.
